(19) United States
(12) Patent Application Publication
(10) Pub. No.: US 2001/0007094 A1
(43) Pub. Date: Jul. 5, 2001

(54) Graphic display processing apparatus and its processing method

(76) Inventors: Fumio Mizuguchi, Takasago-shi (JP); Shuji Endoh, Kobe-shi (JP); Katsuhiko Sakaguchi, Kobe-shi (JP)

Correspondence Address: Wenderoth, Lind & Ponack, Suite 800, 2033 K Street, N.W., Washington, DC, 20006, US

(21) Appl. No.: 09/735,520

(22) Filed: Dec. 14, 2000

(30) Foreign Application Priority Data
Dec. 14, 1999 (JP) 11-354395
Nov. 30, 2000 (JP) 2000-364973

(51) Int. Cl. G06T 15/40; G06F 17/50

(52) U.S. Cl. 703/2; 345/421

(57) ABSTRACT

The graphic display processing apparatus of the present invention is a graphic display processing apparatus that makes graphic display of the stress for the side which is visible when the target made into a model by the plate element in the finite element method structural analysis is seen from the visual point and it is composed of an operating section which calculates the inner product of directional vector from the visual point to the model and the vector perpendicular to the plate element, a judgment section which judges whether the side seen from the visual point is the front side or the back side, depending on whether the inner product obtained by the operating section is positive or negative, and an output section which graphically displays the stress of the front side or back side judged by the judgment section as a stress of the side which is visible from the visual point.

### CROSS-REFERENCE TO RELATED APPLICATIONS

This application is based upon and claims the benefit of priority from the prior Japanese Patent Applications No. 11-354395, filed Dec. 14, 1999; and No. 2000-364973, filed Nov. 30, 2000, the entire contents of which are incorporated herein by reference.

### BACKGROUND OF THE INVENTION

The present invention relates to the graphic display processing apparatus and its processing method that conducts graphic display processing of the stress for the visible side regarding plate element of the finite element method structural analysis.

Among the tools sold on the market for graphic display processing of the analytical results of structural analysis, there are I-DEAS and MSC/PATRAN. However, in the case of these tools, there are no functions to graphically process the stress of the surface that is visible from the visual point regarding the three dimensional plate structure model. The stress of the surface, for instance, in case a downward load is added to the tip of a cantilever, if the top surface is expressed by the front side and the bottom surface is expressed by the back side, the front side will be tensile stress, and the back side will be compressive stress, and they will be different.

In case of graphically displaying surface stress of a plate element in the finite element method structural analysis, FIG. 7 is a flowchart showing the conventional procedure of stress value selection conducted hitherto. Hereinafter, an explanation is given on the procedure of stress value selection by graphical display processing based on FIG. 7.

First, in Step S21 the stress value calculation results of the plate element model based on finite element method that has been calculated separately is input. In Step S22, one plate element is selected in order, in Step S23, the element coordinates x, y, z of the plate elements are determined. In Step S24, the origin is taken on the plate element by the element coordinate system, and the front side of the plate element seen from the plus direction of the vertical direction z axis is set as z1, and the back side of the plate element seen from minus direction is set as z2.

In Step S25, the stress value of the z1 side is stored. In Step S26, the stress value of z2 side is stored. Processing of the above-mentioned Step S22 to the above-mentioned Step S26 is repeated the same number of times as the element number.

In Step S27, the side on which the stress is graphically represented is designated as z1 side or z2 side. Furthermore, in the case of the conventional tool, the instruction method is limited to “graphical representation of z1” and “graphical representation of z2.”

In case z1 is designated here, in Step S28, stress diagram of only z1 side will be made. Furthermore, in case z2 is designated, in Step S29, stress diagram of only z2 side will be made.

In the aforementioned manner, hitherto, the stress of only the front side or back side of the plate element that was set was graphically displayed regardless of the position of the visual point.

FIG. 8 and FIG. 9 are iso-stress level diagrams obtained by conventional tools sold on the market. They are stress diagrams seen from the visual point in case the aforementioned procedure for stress value selection is used. The diagrams shown here were made from photographic-prints of the images that were shown in the display.

FIG. 5 shows the analysis conditions. In FIG. 8, since stresses of the cylinder inner side is expressed without putting into consideration the relation between the visual point and the visible surface, at the portion where it is being pressed, although the outside is visible from the visual point, the stress of the inner side is represented, and it is expressed as tensile stress. In other words, in the case of conventional technology, by designating the stress of the z1 side, the circumferential direction stress near the place where the load is added will become tensile stress for both the outside and inner side of the cylinder that is visible from the visual point, and the stress value is graphically displayed as positive value.

In FIG. 9, since stresses of the cylinder outside is expressed without putting into consideration the relation between the visual point and the visible surface, at the portion where it is being pressed, although the inner side is visible from the visual point, the stress of the outside is represented, and it is expressed as compressive stress. In other words, in the case of conventional technology, by designating the stress of the z2 side, the circumferential direction stress near the place where the load is added will become compressive stress for both the outside and inside of the cylinder that is visible from the visual point, and the stress value is graphically displayed as a negative value.

Therefore, the stress of those certain portions among all sides which are visible from the same visual point will be graphically displayed at the visible surface, but the stress of other remote portions such as the back side will be graphically displayed as if it is visible. Thus, in case of evaluation, it will be misleading.

### BRIEF SUMMARY OF THE INVENTION

The purpose of the present invention is to provide a graphic display processing apparatus and its processing method that makes it possible to obtain stress graphics of only the side that is visible.

The graphic display processing apparatus of the present invention is a graphic display processing apparatus that makes graphic display of the stress for the side which is visible when the target made into a model by the plate element in the finite element method structural analysis is seen from the visual point and it is composed of an operating section which calculates the inner product of directional vector from the visual point to the model and the vector perpendicular to the plate element; a judgment section which judges whether the side seen from the visual point is the front side or the back side, depending on whether the inner product obtained by the operating section is positive or negative; and an output section which graphically displays the stress of the front side or back side judged by the judgment section as a stress of the side which is visible from the visual point.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a drawing that shows the whole composition of the graphic display processing apparatus related to the embodiments of the present invention;

FIG. 2 is a flow chart showing the procedures of stress value selection related to the embodiments of the present invention;

FIG. 3 is a drawing that shows the element coordinate system of the plate elements related to the embodiments of the present invention;

FIG. 4 is a drawing that shows positional relations of vectors that point towards the plate element from the visual point and the vectors that are perpendicular to the plate element related to the embodiments of the present invention;

FIG. 5 is a drawing that shows the calculation model related to the embodiments of the present invention;

FIG. 6 is a drawing that shows the iso-stress level obtained in accordance with the calculation procedure based on the embodiments of the present invention, and it is shown by making photographic-prints of the image indicated on the display;

FIG. 7 is a flowchart that shows the procedures of the stress value selection related to the conventional examples;

FIG. 8 is a stress drawing from the visual point where of the procedures of the stress value selection related to the conventional examples, and it is a drawing that is shown by making photographic-prints of the image indicated on the display; and

FIG. 9 is a stress drawing from the visual point where of the procedures of the stress value selection related to the conventional examples, and it is a drawing that is shown by making photographic-prints of the image indicated on the display.

### DETAILED DESCRIPTION OF THE INVENTION

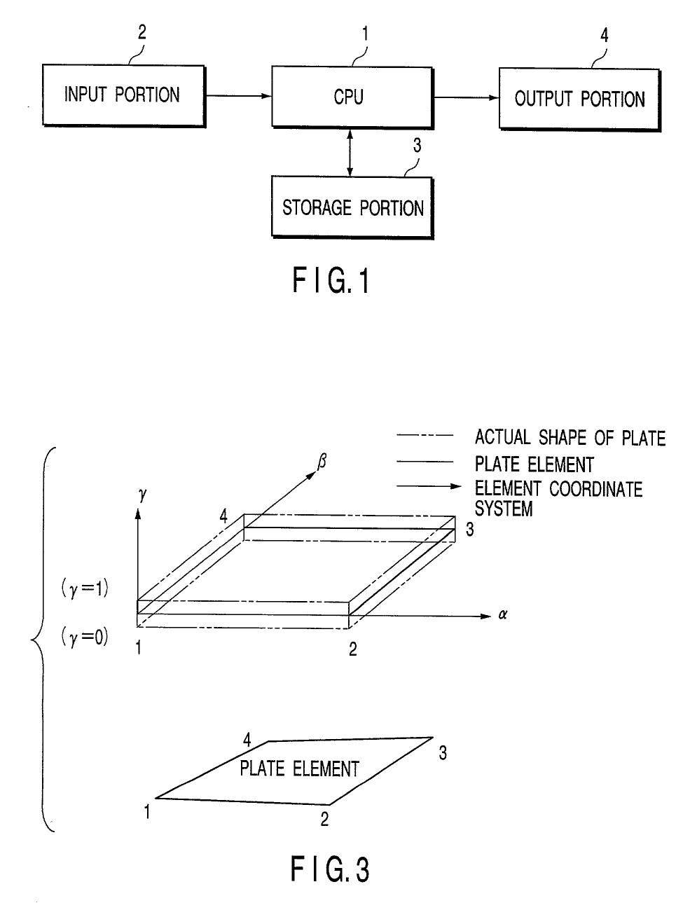

FIG. 1 is a drawing showing the whole composition of the graphic display processing apparatus related to the embodiments of the present invention. In FIG. 1, the input section 2, the storage section 3, and the output section (a display, a printer) 4 are connected to the CPU 1.

In the input section 2, the calculation results of the finite element method structural analysis, that is, the nodal point number and the element dividing data of the connections for the nodal point number that forms its coordinates and plate elements, the nodal point number and the element dividing data being used for an analysis code of a structural system, and the stress calculation results of the plate element for each element are input, then sent as the input data to CPU1 that conducts stress selection of the surface sides.

In CPU1, the stress calculation results of the side visible from the visual point in the plate element for each element is input by the input section 2, and such stress data for each element are sent to the storage section 3. Stress data of all plate elements stored in the storage section 3 are sent to CPU1, and the stress visible from the visual point is selected, then returned to the storage section 3. Data visible from the visual point side of all plate elements gathered in the storage section 3 are sent to the output section 4 via the CPU1, and they are output as iso-stress drawing on the element dividing drawing prepared from the data of the elemental division.

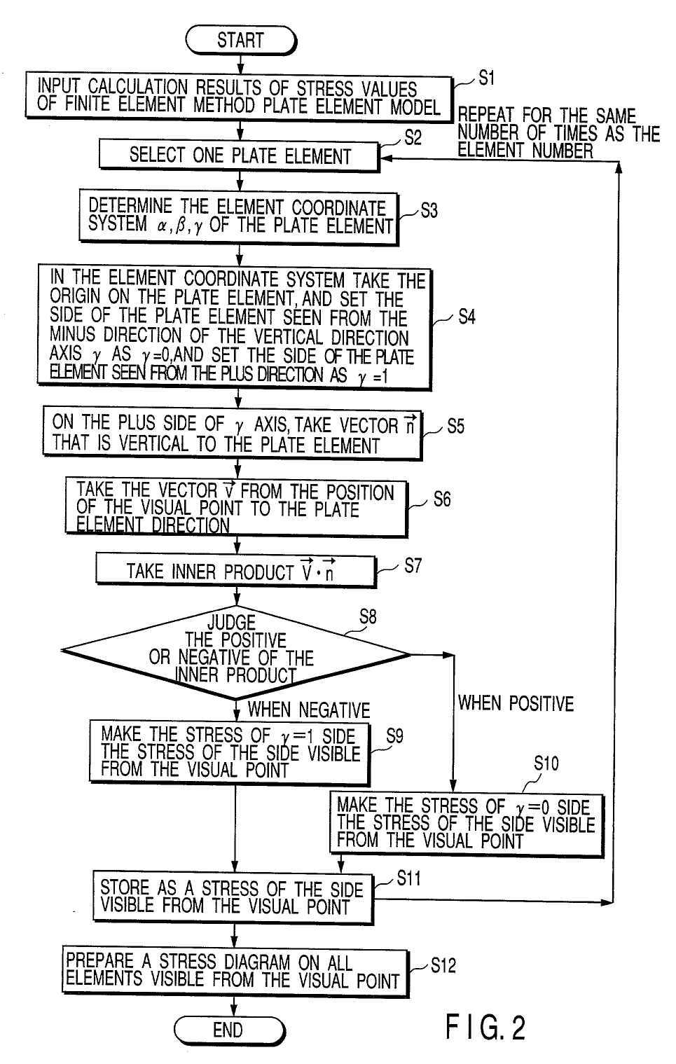

FIG. 2 is a flow-chart that shows the procedure of stress value selection in the present embodiment in case of making graphic display of the surface stress of the plate element of the finite element method structural analysis. Hereinafter, an explanation is given on the procedure of stress value selection based on graphic display processing apparatus having the above composition based on FIG. 2.

First, in Step S1, CPU1 inputs the stress value calculation results of the plate element model based on the finite element method that has been separately calculated. In Step S2, CPU1 selects one plate element in order, and in Step S3, the element coordinate system α, β, γ of the plate element is determined. As mentioned later on, this coordinate system is shown in FIG. 3. In Step S4, CPU1 takes the origin of the element coordinate system on the plate element, and the side of the plate element seen from the minus direction of the vertical direction axis γ is set as γ=0, and the side of the plate element seen from the plus direction is set as γ=1.

In Step S5, CPU1 takes a vector \vec{n} which is vertical to the plate element on the plus side of the γ axis.

In Step S6, CPU1 takes a vector \vec{v} which is in a direction from a visual point to the plate element.

In Step S7, CPU1 calculates the inner product \vec{v}·\vec{n}.

In Step S8, CPU1 judges the positive or negative of the inner product. In case this judgment is negative, in Step S9, CPU1 makes the stress of the side of γ=1 the stress of the side visible from the visual point. Furthermore, in case the judgment is positive, in Step S10, CPU1 makes the stress of the side of γ=0 the stress of the side visible from the visual point.

The stresses that are selected from the aforementioned steps S9 and S10 are sent to the storage section 3 in Step S11, and stored as stress of the side that is visible from the visual point. The processing from the aforementioned Step S2 to the aforementioned Step S11, is repeated the same number of times as the number of elements.

The stress stored by the aforementioned Step S11 is sent to the output section 4 in Step S12, and stress drawings are prepared for all elements visible from the visual point. By doing so, it becomes possible to make graphic display of the stresses that are visible from the visual point.

FIG. 3 is a drawing that shows the element coordinate system of the plate element. In FIG. 3, an example of plate elements consisting of 4 nodal point numbers ‘1’, ‘2’, ‘3’, and ‘4’ is shown. This was made into a model from an actual shape of a plate having thickness.

In FIG. 3, the nodal point ‘1’ is made the origin, and the coordinate axis α is taken in the direction of the nodal point 2. By using nodal point ‘1’ as the origin, the coordinate axis β is taken in the direction of the nodal point ‘4’. In addition, using nodal point ‘1’ as the origin, in case the fingers of the left hand are stretched so that the middle finger, the index finger and the thumb are perpendicular to one another, make the middle finger the α axis, the index finger β axis, and the direction of the thumb γ axis.

The side of the plate element seen from the negative direction of the γ axis, is referred to as γ=0, and the side of the plate element seen from the plus direction of the γ axis is referred to as γ=1. This is conducted from the standpoint of convenience to recognize the side, and they can be set arbitrarily as γ=a, γ=b.

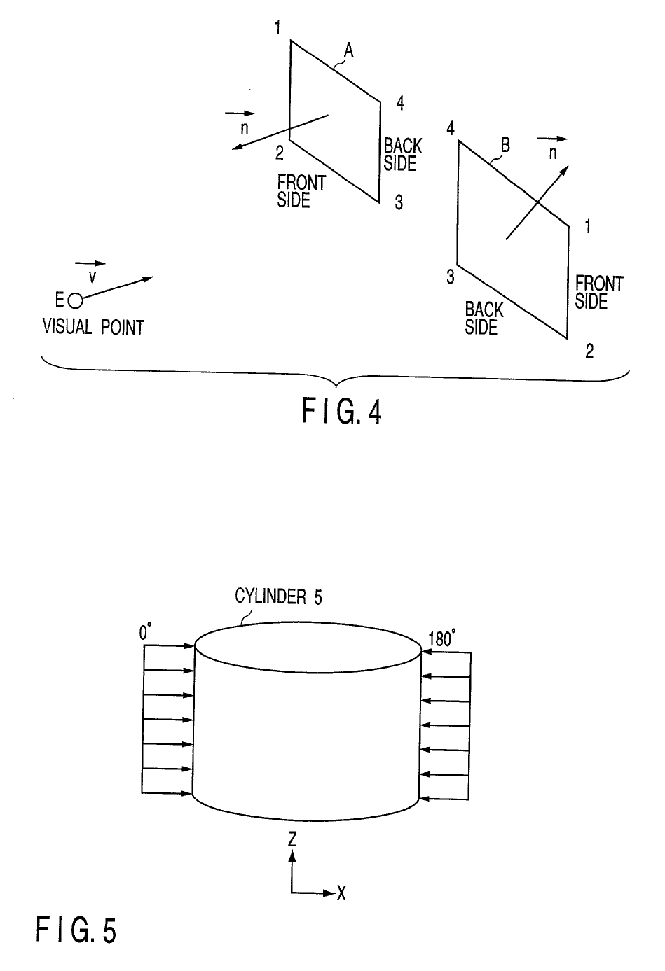

FIG. 4 is a drawing that indicates the positional relation between the vector facing the direction of the plate element from the visual point and the vector that is perpendicular to the plate element. As shown in FIG. 4, the vector perpendicular to the plate element composed of 4 nodal points of nodal point number ‘1’, ‘2’, ‘3’, and ‘4’ are made as follows:

\vec{n}

The direction of \vec{n} is set by the element coordinate system of the left hand system based on the order of the nodal points ‘1’, ‘2’, ‘3’, and ‘4’.

If we express the visual point with E, \vec{n} of element A is facing towards the visual point side, and \vec{n} of element B is facing the opposite direction. In this case, the element surface in the positive direction of the vector \vec{n} is made the front side, and the element surface in the negative direction is made the back side.

Next, vector \vec{v} will be considered from the visual point to the direction of element A, and element B. If we obtain the inner product of these vectors, in element A

\vec{v}·\vec{n}

is in a negative relation, and in element B

\vec{v}·\vec{n}

is in a positive relation.

Therefore, in case the front side is selected when the inner product is negative, and in case the back side is selected when the inner product is positive, they will be the side that can be seen from the visual point.

FIG. 5 is a drawing that shows the calculation model in the present embodiment. Hereinafter, an explanation will be made on the static stress analysis as the target of the simple model shown in FIG. 5. The cylinder 5 shown in FIG. 5 is pressed on the positions of 0 degrees and 180 degrees by adding load along the axis from the outside in the radial direction towards the center axis.

In such a state, the cylinder 5 will be deformed towards the inside at the portion where it is pressed. Near the position where the load is added, if observed from the circumferential stress, at the outside of the cylinder 5 it will be compressive stress and the stress value will be negative, and at the inside of the cylinder 5 it will be tensile stress and the stress value will be positive.

If the outside of cylinder 5 is made the front side, and the inside of cylinder 5 the back side, in spite of both the front side and the back side being visible in the case of conventional technology, since designation can be made only for the stress drawing of the front side or the stress drawing of the back side, the stress of visible side will become a stress drawing of all tensile stress or all compressive stress.

However, in the case of the present embodiment, near the place where the load is added, a stress diagram in which the front side will be compressive stress at a place where the outside can be seen, and the back side will be tensile stress at a place where the inside can be seen, will be obtained.

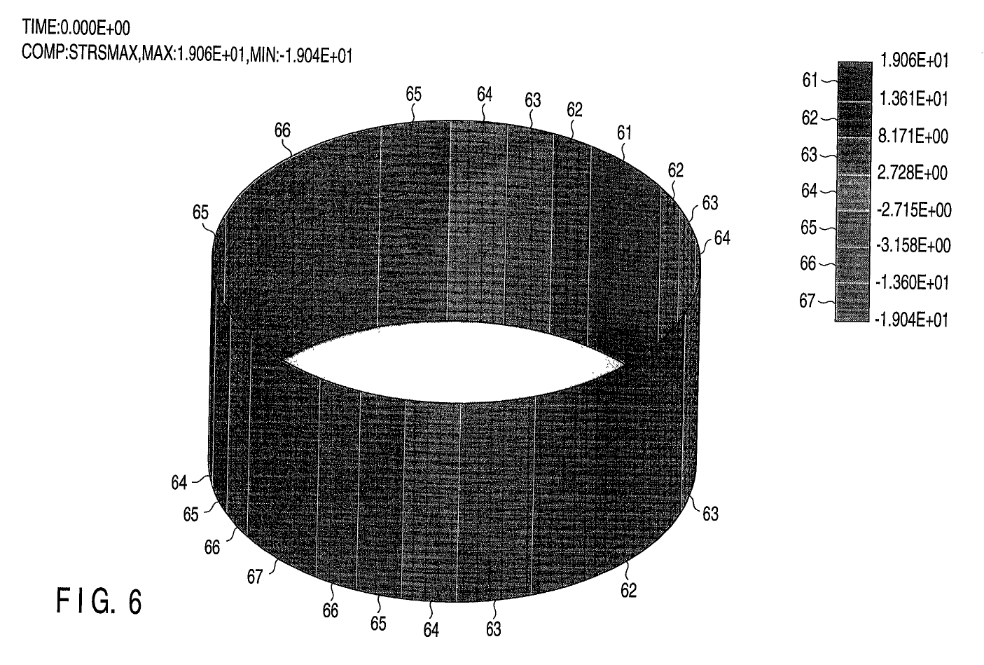

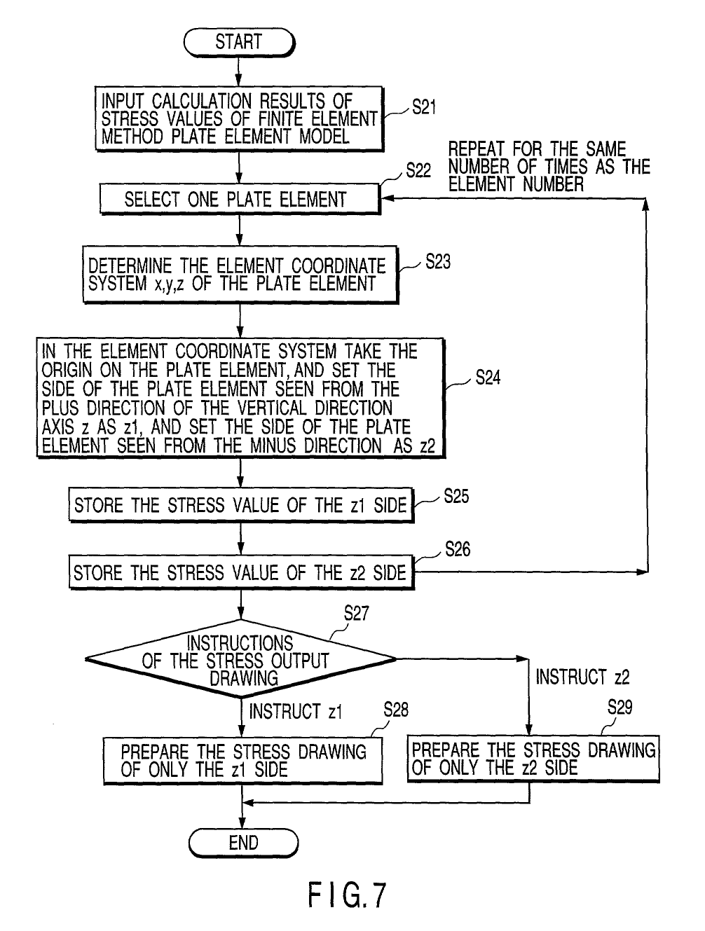

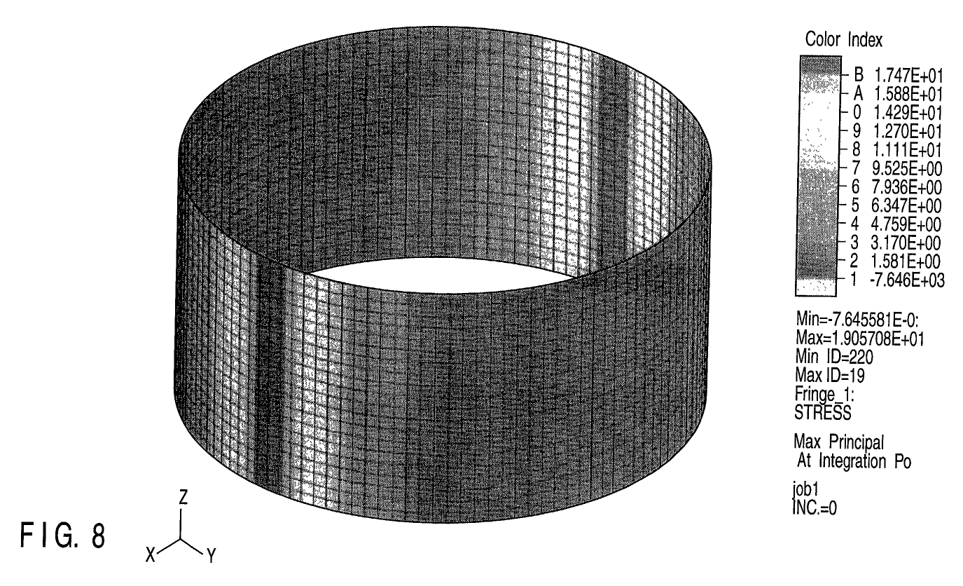

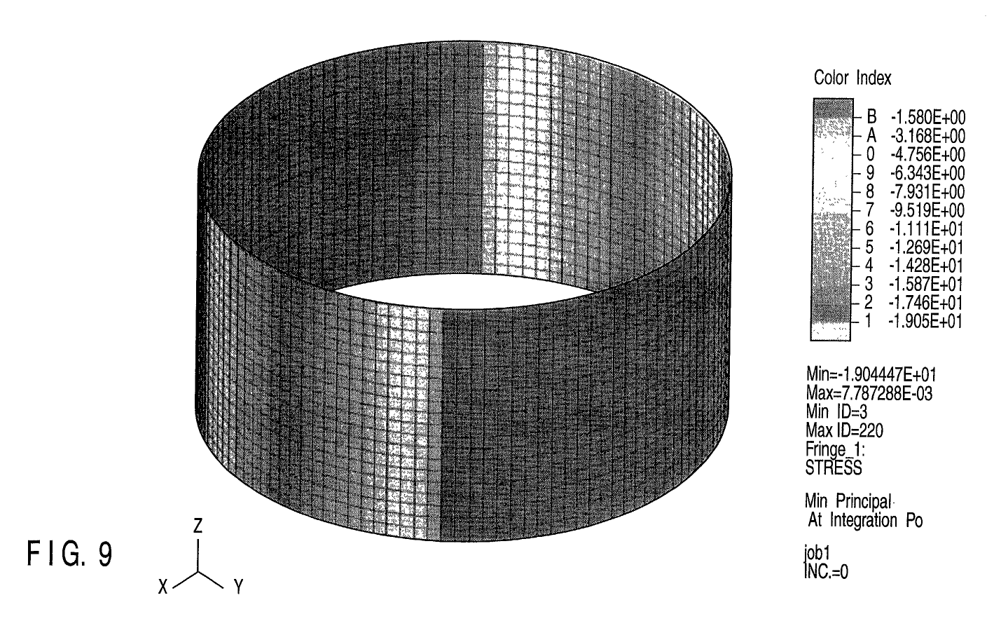

FIG. 6 is a drawing that shows the iso-stress level obtained in accordance with the calculation procedure based on the embodiments of the present invention, and it is a stress drawing from the visual point in case the above mentioned procedure of the stress value selection is used. FIG. 6 is a drawing that shows the photographic-prints of the image indicated on the display of the output section 4. In the iso-stress level drawing shown in the center of FIG. 6, the portions corresponding to stress value (61-67) on the upper right side are shown by the identical reference numbers (61-67).

As shown in FIG. 6, at the portion that is being pressed, in case the side being seen is the outside, graphical display will be made as compressive stress, and in case the side being seen is the inside, the graphical display will be made as tensile stress. In this way, in the present embodiment, the circumferential direction stress near the place where the load is added will be compressive stress where the outside of the cylinder is visible, and graphical display will be made so that the stress value will be negative (minus). The circumferential direction stress near the place where the load is added will be tensile stress where the inside of the cylinder is visible, and the graphical display will be made so that the stress value will be positive (plus).

According to the graphical display processing apparatus and its method in the present invention, it is possible to obtain the stress drawing of only the side that is visible from the visual point, and a stress drawing in which the front side becomes compressive stress at a place where the outside of the target is visible, and the back side becomes tensile stress at a place where the inside of the target is visible, is obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A graphic display processing apparatus that makes graphic display of the stress for the side which is visible when the target made into a model by the plate element in the finite element method structural analysis is seen from the visual point, said graphic display processing apparatus comprising:
an operating section which calculates the inner product of directional vector from the visual point to the model and the vector perpendicular to the plate element;
a judgment section which judges whether the side seen from the visual point is the front side or the back side, depending on whether the inner product obtained by the operating section is positive or negative; and
an output section which graphically displays the stress of the front side or back side judged by the said judgment section as a stress of the side which is visible from the visual point.

2. A graphic display processing method that graphically expresses the stress of the plane when the target made into a model by the plate element in the finite element method structural analysis is seen from the visual point, said graphic display processing method comprising the steps of:
calculating the inner product of directional vector from the visual point to the model and the vector perpendicular to the plate element;
judging whether the side seen from the visual point is the front side or the back side, depending on whether the inner product is positive or negative; and
graphically displaying the stress of the front side or back side as a stress of the side which is visible from the visual point.
